(19) United States
(12) Patent Application Publication
(10) Pub. No.: US 2009/0291686 A1
(43) Pub. Date: Nov. 26, 2009

(54) Autonomous connectivity between a mobile station and multiple network elements for minimizing service discontinuities during handovers in a wireless communication system

(75) Inventors: Yaron Alpert, Hod Hasharon (IL); Jonathan Segev, Tel Mond (IL); Erez Ben-Tovim, Ra'anana (IL)

Correspondence Address: Zaretsky Patent Group PC, 20783 N 83rd Ave, Ste 103-174, Peoria, AZ, 85382-7430, US

(73) Assignee: Comsys communication & Signal Processing Ltd.

(21) Appl. No.: 12/124,391

(22) Filed: May 21, 2008

(51) Int. Cl. H04Q 7/20

(52) U.S. Cl. 455/436

(57) ABSTRACT

A novel and useful autonomous connectivity mechanism for use in user equipment (UE) connectivity in one or more cellular communications systems. The handover process is optimized by improving the selection of target base stations and optimizing the discontinuity period from the time of disconnection from a serving base station and connection to a target base station. The mechanism facilitates multiple cell connectivity in a network unaware manner while preserving single endpoint connectivity. The UE does not need to negotiate for or receive pre-allocated opportunities from the network for making neighboring base stations measurements. Measurement opportunities are created by the UE autonomously in accordance with UE activity patterns. Measurement opportunities are used to measure and maintain a candidate target base station list over the same or a plurality of access technologies. The parameter set tracked includes parameters that can be measured without any assistance from the target base station and which can effect the handover process, e.g., link quality, etc.

### REFERENCE TO RELATED APPLICATION

This application is related to U.S. application Ser. No. ______, filed May 21, 2008, entitled “Autonomous anonymous association between a mobile station and multiple network elements in a wireless communication system,” incorporated herein by reference in its entirety.

### FIELD OF THE INVENTION

The present invention relates generally to wireless communication systems and more particularly relates to an apparatus for and method of autonomous connectivity between a mobile station and multiple network elements in a wireless communication system.

### BACKGROUND OF THE INVENTION

Cellular networks, well known in the art, are in widespread use around the world. A cellular network is a radio network made up of a number of cells wherein each cell is served by a base station (i.e. cell site). Cells are used to cover geographic areas to provide radio coverage over a wider area than the area of any one cell. Radio transceivers in each cell communicate with multiple mobile stations within its coverage region.

A diagram illustrating an example prior art cellular network is shown in FIG. 1. The network, generally referenced 10, comprises a network cloud 18 having a plurality of base stations and mobile stations (MSs). A mobile station 16 is normally connected to a serving base station (BS) 12 or serving cell via wireless link connection 13. The mobile unit or mobile station (MS) 16 is synchronized and registered into the network using wireless link connection 13 to the base station 12. Depending on its location, the mobile station may receive signals from not only serving base station 12 but also from other base stations that are considered candidate base stations or candidate cells 14 via “links” (as indicated by dashed arrow 15).

In cellular and other wireless communication systems, one or more mobile stations may establish a wireless link to a Radio Access Network (RAN). Call state information associated with each mobile station call session is stored in the network, where it is feasible to use a central repository such as a Radio Network Controller (RNC), a Packet Data Serving Node (PDSN), etc. or to use a distributed network architecture (e.g., WiMAX BS and ASN gateways).

In a cellular network, the handoff or handover process refers to the process of transferring an ongoing call or data session from one RAN channel to another. The details of the handoff process differ depending on the type of wireless link connection, network and the factors causing a need for the handoff. For example, one of the handoff restrictions is typically not to interrupt ongoing communications between the mobile station and the base station or to set this un-connectivity time to minimal. In this case, there must be clear coordination between the base station and the mobile station. As the mobile station moves from one cell area to another, the base station commands the mobile station to tune to a new radio channel or allocation that is considered as more suitable for maintaining the connection. When the mobile station responds through the new cell site, the network switches the connection to the new cell site accordingly.

The predicted handoff process, in case the MS does not lose connectivity within the network, is a network managed process that proceeds in a master/slave manner. In this case, the network allocates bandwidth for control and signaling. In the prior art managed handoff process, the network may instructs the user equipment (i.e. MS) to execute measurements and to report results of these measurements to the network. Based on these results or other network considerations, the network makes the handoff decision. A disadvantage of this type of handoff process, however, is that it consumes resources and reduces capacity due to need for the interaction of messages between the network and the user equipment and the additional delay occurs due to the MS measurements and reporting time. In addition, the handoff decision may be suboptimal due to the allocation pattern of measurements opportunity by the network and the reporting time delays.

In unpredicted handover, the MS maintains connectivity with the network but performs a handover to a target base station without permission from the serving base station, rather than using a network managed process that normally takes place in a master/slave arrangement in a predicted handover. An unpredicted handover, however, has advantages over predicted handover in that unpredicted handover does not consume resources and does not reduce network capacity since there is no interaction of messages between the network and user equipment. A disadvantage, however, is that TBS network entry time is extended.

A handoff may occur for several reasons, examples of which include: (1) in case the MS moves away from an area covered by a serving first cell and enters an area covered by another second cell, the call is transferred to the second cell in order to avoid call termination; (2) when the capability for connecting new sessions or maintaining existing sessions within a given cell is exceeded and the sessions is transferred to another cell in order to free up capacity in the first cell; and (3) in some networks, when channel interference is caused by another MS using the same channel in a different cell, the call is transferred to a different channel in the same cell or to a different channel in another cell in order to avoid the interference.

Handoffs can be divided into hard and soft handoffs. In a hard handoff, the link level connectivity in the serving cell is first terminated, then the link level connectivity to a selected target cell is engaged. Such handoffs are thus referred to as a break-before-make process. Therefore, it is desirable to minimize the time to implement a hard handoff in order to minimize any disruption to the sessions. In many applications (such as real time applications) it is critical that any discontinuity in the handoff process be reduced to a minimum. Real time service applications such as video sessions or voice sessions are very sensitive to discontinuities during handoff as the results range from annoying delay to dropped sessions. Note that the discontinuity duration is related to the level of synchronization between the MS and the Target BS (TBS) and the underlying network handoff protocol.

In addition, it is desirable to maximize the probability of success of the handover process since failure to handoff to the Target BS (TBS) or reverting to the Source SB (SBS) results in sessions being dropped. The probability of success of the handoff process is typically affected by two factors: (1) the quality and timing of the handoff decision and (2) the synchronization of the MS receiver to the new assigned channel (or recourse) in the TBS.

In a soft handoff, the link level connectivity to the SBS is retained and used in parallel with the link level connectivity to the TBS for a short period of time. This process if fully control and coordinate by the network. Since the link level connectivity to the TBS is established before the link level connectivity to the SBS is broken, such handoffs are referred to as make-before-break. Note that a soft handoff may involve connections to more than two TBS. When a session is in a state of soft handoff, the best signal from among the available links is utilized for the session.

To execute a handoff each cell is assigned a list (i.e. the neighbor list) of potential target cells (TBSs), which can be used for handing off calls to. During MS connectivity of a certain cell, one or more parameters of the signal in the link in the source cell (SBS) are monitored by the BS, monitored by the MS and reported to the BS and assessed by the MS, BS or other network element in order to decide whether a handoff is necessary. The handoff may be requested by the MS, by the base station (BS) or other network element. The MS may monitor based on set of instruction send by the SBS signals of best target candidates selected among the neighboring cells.

The parameters used as criteria for requesting a hard handoff may include (depending on the particular system): actual or estimates of the received signal power, received signal-to-noise ratio, bit error rate (BER) and block error/erasure rate (BLER), packet error rate (PER), burst error rate (BuER), received quality of sessions (i.e. speech quality, video quality level, etc.), SNR, RTD, interferences level, CQI, HARQ retransmission level/success ratio, distance between the MS and the BS estimated based on radio signal propagation delay, Ec/Io ratio measured of common or dedicated transmission elements.

A diagram illustrating a prior art handover preparation and execution flow is shown in FIG. 2. In the handover preparation stage 230, the target base station (TBS) HO parameters are received for the serving base station (SBS) (step 220). After getting an appropriate command from the SBS the MS follow into HO execution phase. The HO execution phase starts when the mobile station (MS) synchronizes with the TBS (step 222) and decodes the downlink (DL) information received from the TBS (step 224). The MS then performs identification and capability negotiation (i.e. the MS identifies to the TBS and exchanges relevant information) (step 226) between the mobile station and the new target base station to establish network connectivity at the TBS. The network then re-connects to the new TBS (step 228) and resumes the active sessions.

In prior art mobile communication systems, MS connectivity is fully controlled by the network using the air link interface to the serving base station. Decisions as to which base station should be monitored is fully controlled and managed by the network. The connectivity capability from the mobile station to the serving base station is also controlled by the network (i.e. handover process). Prior art protocols are used to update and control the selection of the candidate base stations. The MS does not initiate any attempts to connect to the TBS unless a link loss to the SBS occurs. The MS then performs an unpredicted HO presses.

Further, in prior art MS connectivity techniques, the selection of a base station for handover, including handover initiation and control, is based on the direct instruction of and with the assistance of support information provided by the serving base station. The user equipment may be instructed by the serving base station, during the handover preparation stage, to perform measurements of specific signals from a certain base station according to a specific schedule.

The ability to perform quick handovers is becoming increasingly important, especially in light of the fact that in the next generation of mobile communication networks, the radius of the cell will become smaller, causing more frequent handovers and disconnection of existing handover calls if the channel capacity for handover is insufficient. One of the major problems in mobile communications, however, is how to optimize (i.e. minimize) the discontinuity and unavailability caused by handovers in broadband wireless networks. Typically, mobile stations must negotiate or receive pre-allocated opportunities for measuring neighboring base stations and in these unavailability periods the MS is unavailable to the SBS and therefore faces service discontinuities.

The length of the discontinuity period during the HO execution phase may be affected by any or all of the following: (1) uncertainties related to the actual link condition from the MS to the target base station and to the serving base station which may lead to loss of network connectivity and a long synchronization period before the handover process is successfully completed; (2) not being able to maintain suitable quality of service (QoS) in terms of service continuity due to the loss of network connectivity; (3) the addition of radio frequency (RF) circuitry and CPU processing capability which increases the cost of manufacturing the mobile station, i.e. the quality of the MS; (4) the inability to acquire the target base station parameters (i.e. from serving base station advertising or otherwise) creating the need to establish link level connectivity and full network connections; (5) the inability to provide necessary SBS control support for existing connections (6) the requirement for specific coordination between the base stations to manage the mobile station air interface resources; and (7) the long acquisition time required to obtain (i.e. discover and detect) target base station synchronization and decoding parameters, control information and messages due to any previous acquisition being preformed a long time ago.

The result of the problems described above is to significantly extend the execution time for the handover HO execution phase and MS unavailability during the HO preparation phase to significantly degrade the probability of achieving a successful handover while maintaining a sufficient level of network connectivity and QoS to prevent the interruption of user connectivity.

Thus, there is a need for a mechanism that is capable of improving the quality and reliability of the handover process between a mobile station and multiple network elements while minimizing or eliminating the air link and service discontinuity time due to handover in wireless communication networks.

### SUMMARY OF THE INVENTION

Accordingly, the present invention provides a novel and useful apparatus for and method of autonomous MS connectivity in cellular communications systems. The autonomous connectivity mechanism of the present invention optimizes the handover process and system QoS level by decreasing the period(s) that the MS is unavailable, improving parameter acquisition and selection of target base stations and by optimizing the discontinuity period from the time of disconnection from a serving base station and connection to a target base station. The autonomous connectivity mechanism significantly improves the overall QoS in cellular communications systems, especially the quality and reliability of the handover process by the use of a novel autonomous connectivity methodology between a mobile station and a plurality of network elements.

The mechanism of the invention improves handover in cellular communication systems by optimizing the discontinuity period during the handover procedure and decreasing the drop ratio (i.e. the failure to connect to the TBS). The mechanism is operative to improve the reliability of the handover process and reduce the service discontinuity time due to handovers in communication systems such as Broadband Wireless Access (BWA) networks. The mechanism is applicable to a MS using either a single RF receiver or multi-RF (i.e. wideband) receiver. The mechanism facilitates multiple cell connectivity in a common or distributed BW allocation in a network unaware manner (i.e. autonomous multi-cell connectivity at the serving base station and the target base station without any intervention by the network) while preserving single endpoint connectivity. The mechanism works without any modification to current access protocols.

Thus, in accordance with the invention, the MS does not need to negotiate for or receive pre-allocated opportunities from the network to measure neighbor base stations. Further, measurement opportunities are created by the user equipment autonomously in accordance with current activity patterns, thereby eliminating any bandwidth waste. The measurement opportunities are used by the user equipment to measure and maintain a real time and a non real time database of candidates for target base stations (i.e. neighboring cells). The databases can be based on the SBS neighboring list or self discovery and on detection of candidates or a combination of both, wherein the parameter set tracked includes those parameters that (1) can be measured without any assistance from the target base station and (2) may effect the handover process, such as received signal quality, frequency synchronization, signal power synchronization, etc.

The invention thus provides a mobile station with the capability of performing handovers that optimize the discontinuity period. Advantages of the autonomous connectivity mechanism include (1) minimizing or eliminating altogether the disconnect period from the current serving base station to a selected target base station reception; (2) improving the reliability and connectivity success ratio of the handover process (3) improving QoS.; and (4) enabling autonomous multi-cell connectivity without any awareness by or assistance from the network while maintaining single endpoint connectivity.

The handover switching time minimization mechanism of the present invention is suitable for use in many types of wireless communication systems without protocol modifications. For example, the mechanism is applicable to broadband wireless access (BWA) systems and cellular communication systems. An example of a broadband wireless access system the mechanism of the present invention is applicable to is the well known WiMAX wireless communication standard. An example cellular communication system the mechanism of the present invention is applicable to is the well known GSM wireless communication system. The mechanism of the invention is also applicable to one of the third-generation (3G) mobile phone technologies known as Universal Mobile Telecommunications System (UMTS), Code Division Multiple Access (CDMA), Enhanced Data rates for GSM Evolution (EDGE) and Wireless Local Area Network (WLAN) wireless communication systems.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method for use on a mobile station connected to a network, the method comprising the steps of selecting a set of one or more candidate target base stations, performing autonomous signaling discovery and detection on the set of one or more candidate target base stations over the same or across a plurality of access technologies and updating the selection based on measurements obtained via the autonomous signaling discovery and detection.

There is also provided in accordance with the invention, a method for use on a mobile station connected to a network, the method comprising the steps of selecting a set of one or more candidate target base stations, performing autonomous signaling discovery and detection on the set of one or more candidate target base stations over the same or across a plurality of access technologies, updating the selection based on measurements obtained via the autonomous signaling discovery and detection, initiating a handover procedure to a specific candidate target base station.

There is further provided in accordance with the invention, a method of maintaining connectivity between a mobile station and a plurality of target base stations in a network, the method comprising the steps of autonomously detecting potential target base stations in the network to generate a candidate target base station list, autonomously performing signal discovery and detection measurements on the candidate target base stations over the same or across a plurality of access technologies, ranking base stations in the candidate target base station list in accordance with a predefined criteria and autonomously updating the signal discovery and detection measurements and updating the candidate target base station list in accordance therewith.

There is also provided in accordance with the invention, an apparatus for maintaining connectivity between a mobile station and a plurality of target base stations in a network comprising a modem operative to receive and transmit radio frequency (RF) signals over the network, the modem comprising a cellular connectivity decoder, a memory for storing candidate target base stations and parameter information associated therewith, a processor coupled to the modem, the processor operative to autonomously detect potential target base stations in the network to generate a candidate target base station list, autonomously perform signal detection and measurements on the candidate target base stations over the same or across a plurality of access technologies, rank base stations in the candidate target base station list in accordance with a predefined criteria and autonomously update the signal detection and measurements and update the candidate target base station list in accordance therewith.

There is further provided in accordance with the invention, a mobile station comprising a radio transceiver and associated media access control (MAC) operative to receive and transmit signals over a radio access network (RAN) to a serving base station and to receive signals over the RAN from one or more target base stations, connectivity means coupled to the radio transceiver for maintaining connectivity to a plurality of target base stations in a network, the connectivity means operative to select a set of one or more candidate target base stations, perform autonomous signaling discovery and detection on the set of one or more candidate target base stations over the same or across a plurality of access technologies, update the selection based on measurements obtained via the autonomous signaling discovery and detection and a processor operative to send and receive data to and from the radio transceiver and the connectivity means.

### BRIEF DESCRIPTION OF THE DRAWINGS

The invention is herein described, by way of example only, with reference to the accompanying drawings, wherein:

FIG. 1 is a diagram illustrating an example prior art cellular mobile communications system;

FIG. 2 is a diagram illustrating a prior art handover preparation and execution flow;

FIG. 3 is a block diagram illustrating an example mobile device incorporating the autonomous connectivity mechanism of the present invention;

FIG. 4 is a diagram illustrating an overview of multi-cell connectivity;

FIG. 5 is a diagram illustrating an overview of multi-cell connectivity from a signal intensity perspective;

FIG. 6 is a general block diagram illustrating the multi-cell connectivity user equipment of the present invention;

FIG. 7 is a state diagram illustrating the multi-cell connectivity user equipment state machine;

FIG. 8 is a diagram illustrating autonomous connectivity state functionality and the reduced handover requirements using the mechanism of the present invention;

FIG. 9 is a diagram illustrating the multi-cell connectivity from the mobile station to the network in accordance with the present invention;

FIG. 10 is a diagram illustrating multi-cell connectivity detection state functionality;

FIG. 11 is a diagram illustrating handover preparation and execution flow with the multi-cell connectivity mechanism of the present invention;

FIG. 12 is a flow diagram illustrating the general multilevel discovery, detection and decoding method of the present invention;

FIG. 13 is a diagram illustrating the candidate base station selection and handover initiation process;

FIG. 14 is a diagram illustrating and example mechanism for TBS and CBS selection and handover initiation;

FIG. 15 is a block diagram illustrating an example multi-cell connectivity WiMAX receiver constructed in accordance with the present invention;

FIG. 16 is a flow diagram illustrating a multilevel discovery, detection and decoding method of candidate base stations for WiMAX networks;

FIG. 17 is a block diagram illustrating an example multi-cell connectivity GSM receiver constructed in accordance with the present invention; and

FIG. 18 is a flow diagram illustrating a multilevel discovery, detection and decoding method of candidate base stations for GSM networks.

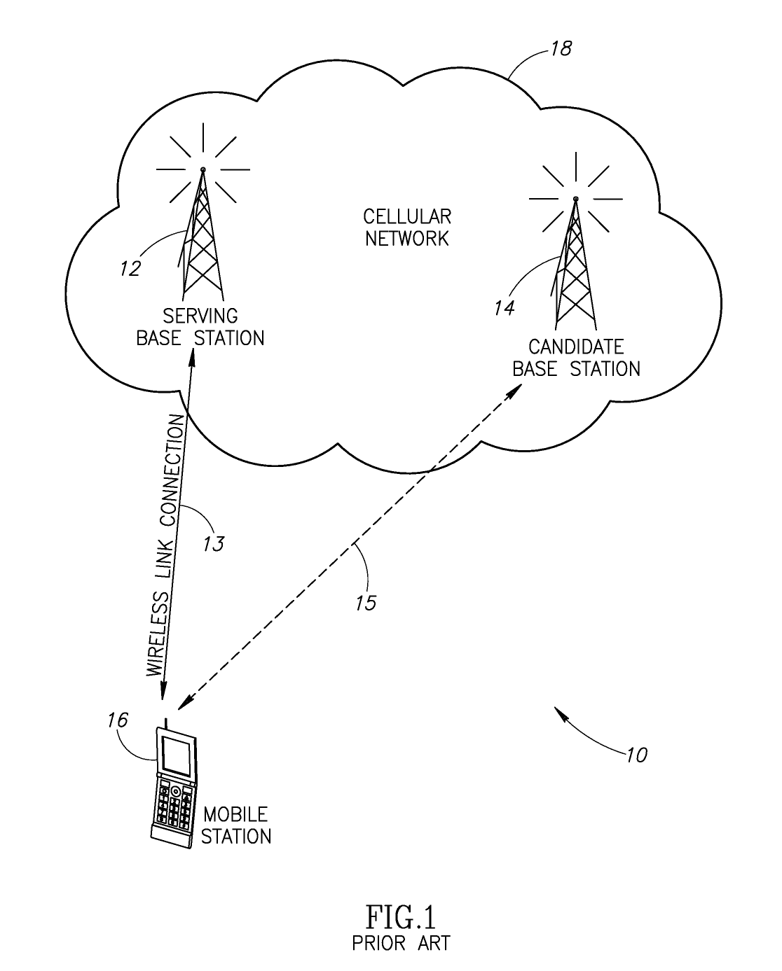

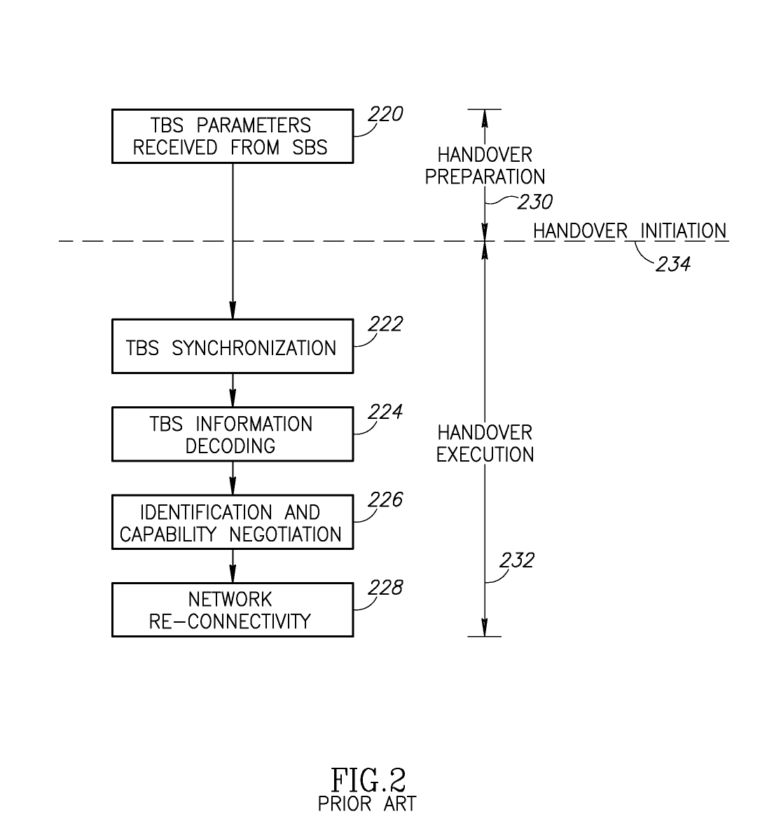

### DETAILED DESCRIPTION OF THE INVENTION

### Notation Used Throughout

The following notation is used throughout this document.

| Term | Definition |
|---|---|
| ABS | Anchor Base Station |
| AC | Alternating Current |
| ASIC | Application Specific Integrated Circuit |
| BA | BCCH Allocation |
| BB | Baseband |
| BCCH | Broadcast Control Channel |
| BLER | Block Error Rate |
| BS | Base Station |
| BW | Bandwidth |
| BWA | Broadband Wireless Access |
| CC | Connection Context |
| CDMA | Code Division Multiple Access |
| CID | Connection ID |
| CNIR | Carrier to Interferences and Noise Ratio |
| CP | Cyclic Prefix |
| CPU | Central Processing Unit |
| CQI | Channel Quality Indicators |
| CTBS | Candidate Target Base Station |
| DC | Direct Current |
| DCD | Downlink Channel Descriptor |
| DIUC | Downlink Interval Usage Code |
| DL | Downlink |
| DL-MAP | Downlink Medium Access Protocol |
| EDGE | Enhanced Data rates for GSM Evolution |
| FA | Foreign Agent |
| FB | Frequency Burst |
| FCCH | Frequency Correction Channel |
| FCH | frame control header |
| FDMA | Frequency Division Multiple Access |
| FEC | Forward Error Correction |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid Automatic Repeat Request |
| HDL | Hardware Description Language |
| HO | Handover |
| ID | Identification |
| IE | Information Element |
| IEEE | Institute of Electrical and Electronic Engineers |
| KPI | Key Performance Indicators |
| LAC | Location Area Code |
| LAN | Local Area Network |
| MAC | Media Access Control |
| MNC | Mobile Network Code |
| MOB-NBR-ADV | Mobile Neighbor Advertisement |
| MPDU | MAC PDU |
| MS | Mobile Station |
| NMT | Nordic Mobile Telephony |
| PBCCH | Packet Broadcast Control Channel |
| PCI | Peripheral Component Interconnect |
| PDA | Personal Digital Assistant |
| PDSN | Packet Data Serving Node |
| PDU | Protocol Data Unit |
| PER | Packet Error Rate |
| PN | Pseudo Noise |
| PRBS | Pseudo Random Binary Sequence |
| PSI | Packet System Information |
| QoS | Quality of Service |
| RAC | Routing Area Code |
| RAM | Random Access Memory |
| RAN | Radio Access Network |
| RAT | Radio Access Technology |
| RF | Radio Frequency |
| RNC | Radio Network Controller |
| ROM | Read Only Memory |
| RSSI | Receive Signal Strength Indication |
| RTD | Round Trip Delay |
| SBS | Serving Base Station |
| SCH | Synchronization burst |
| SDIO | Secure Digital Input/Output |
| SIM | Subscriber Identity Module |
| SPI | Serial Peripheral Interface |
| TBS | Target Base Station |
| TDMA | Time Division Multiple Access |
| TS | Training Sequence |
| TV | Television |
| UCD | Uplink Channel Descriptor |
| UE | User Equipment |
| UIUC | Uplink Interval Usage Code |
| UL | Uplink |
| UMTS | Universal Mobile Telecommunications System |
| USB | Universal Serial Bus |
| UWB | Ultra Wideband |
| WCDMA | Wideband Code Division Multiple Access |
| WiFi | Wireless Fidelity |
| WiMAX | Worldwide Interoperability for Microwave Access |
| WLAN | Wireless Local Area Network |

### Detailed Description of the Invention

The present invention is a novel and useful apparatus for and method of autonomous MS connectivity in cellular communications systems. The autonomous connectivity mechanism of the present invention improves QoS by optimizing the handover process by improving the selection of target base stations and by optimizing the discontinuity period from the time of disconnection from a serving base station and connection to a target base station and by reducing the HO failure rate. The autonomous connectivity mechanism significantly improves the quality and reliability of the handover process using a novel autonomous connectivity methodology between a mobile station and a plurality of network elements.

The mechanism of the invention improves handover in cellular communication systems by optimizing the discontinuity period during the handover procedure to decrease the drop rate (i.e. the failure to connect to the TBS). The mechanism is operative to improve the reliability of the handover process and reduce the service discontinuity time due to handovers in communication systems such as Broadband Wireless Access (BWA) networks. The mechanism facilitates multiple cell connectivity in a network unaware manner (i.e. autonomous multi-cell connectivity at the serving base station and the target base station without any intervention by the network) while preserving single endpoint connectivity.

The handover switching time minimization mechanism of the present invention is suitable for use in many types of wireless communication systems without protocol modifications. For example, the mechanism is applicable to broadband wireless access (BWA) systems and cellular communication systems. An example of a broadband wireless access system the mechanism of the present invention is applicable to is the well known WiMAX wireless communication standard. An example cellular communication system the mechanism of the present invention is applicable to is the well known GSM wireless communication system. The mechanism of the invention is also applicable to one of the third-generation (3G) mobile phone technologies known as Universal Mobile Telecommunications System (UMTS), Code Division Multiple Access (CDMA), Enhanced Data rates for GSM Evolution (EDGE) and Wireless Local Area Network (WLAN) wireless communication systems.

To aid in illustrating the principles of the present invention, the autonomous connectivity mechanism is presented in the context of both a WiMAX and GSM communication system. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, CDMA-2000, EVDO, EVDV, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The term mobile station is defined as all user equipment and software needed for communication with a network such as a RAN. The term mobile station is also used to denote other devices including, but not limited to, a multimedia player, mobile communication device, cellular phone, node in a broadband wireless access (BWA) network, smartphone, PDA and Bluetooth device. A mobile station normally is intended to be used in motion or while halted at unspecified points but the term as used herein also refers to devices fixed in their location.

The word ‘exemplary’ is used herein to mean ‘serving as an example, instance, or illustration.’ Any embodiment described herein as ‘exemplary’ is not necessarily to be construed as preferred or advantageous over other embodiments.

The terms ‘autonomous connectivity,’ ‘autonomous multi-cell connectivity,’ ‘handover switching time minimization’ and ‘handover optimization’ are all intended to refer to the mechanism of the present invention which provides autonomous connectivity between a user equipment and multiple candidate target base stations. The mechanism autonomously maintains simultaneous and non simultaneous, real time and non real time, connectivity to multiple network elements for the purpose of discovering, detecting, measuring, maintaining, decoding information, connecting into a broadcast transmission, and tracking a database of neighbor cells for the purpose of reducing or eliminating service discontinuity time during the handover process.

The serving base station (SBS) is defined as the base station the mobile station is registered with in the network which provides the air interface connectivity. The connection context (CC) is defined as the complete set of parameters that define to the network the connection capabilities, current connection set and status of a specific mobile station. The target base station (TBS) is defined as a base station that is the target for a handover process. A candidate target base station is a base station that the mobile station or other network element considers a potential target base station in its decision and selection process. The handover process is a transition from the SBS to a selected target base station. The connection context of the MS is provided by the network elements based on authorization, authentication and link status between the SBS to the MS. As part of the handover process, the SBS transfers the connection context to the TBS which becomes the new serving base station before, during and/or after the handover is complete.

Note also that the terms connected and serving base station are intended the mean the same thing. Similarly with the following pairs of terms: channel and link; MS and user equipment (UE); source and serving base station; channel and link level connectivity; target cell and TBS; and call and session.

### Mobile Station Incorporating the Autonomous Connectivity Mechanism

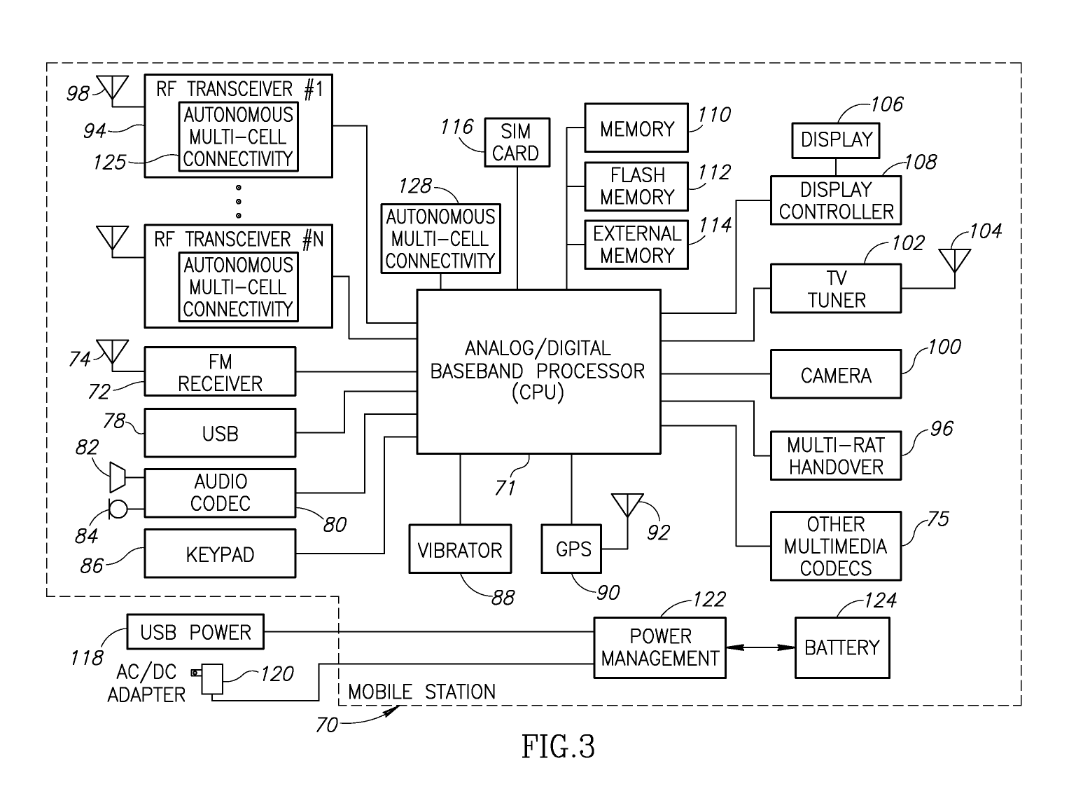

A block diagram illustrating an example mobile device incorporating the autonomous connectivity mechanism of the present invention is shown in FIG. 3. Note that the mobile station may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the autonomous connectivity mechanism of the present invention can be implemented in a wide variety of communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE 3G; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60G device; UWB; etc. One or more of the RF transceivers may comprise an additional a plurality of antennas to provide antenna diversity which yields improved radio performance. The mobile station may also comprise internal RAM and ROM memory 110, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc.

The mobile station comprises a multi-RAT handover block 96 which may be a executed as a task on the baseband processor 71. The mobile station also comprises autonomous multi-cell connectivity blocks 125, 128 which may be implemented in any number of the RF transceivers 94. Alternatively (or in addition to), the autonomous multi-cell connectivity block 128 may be implemented as a task executed by the baseband processor 71. The autonomous multi-cell connectivity blocks 125, 128 are adapted to implement the autonomous connectivity mechanism for inter and intra-access technology HO of the present invention as described in more detail infra. In operation, the autonomous multi-cell connectivity blocks may be implemented as hardware, software or as a combination of hardware and software. Implemented as a software task, the program code operative to implement the autonomous connectivity mechanism of the present invention is stored in one or more memories 110, 112 or 114 or local memories within the Baseband.

Portable power is provided by the battery 124 coupled to power management circuitry 122. External power is provided via USB power 118 or an AC/DC adapter 120 connected to the battery management circuitry which is operative to manage the charging and discharging of the battery 124.

### Autonomous Connectivity Mechanism

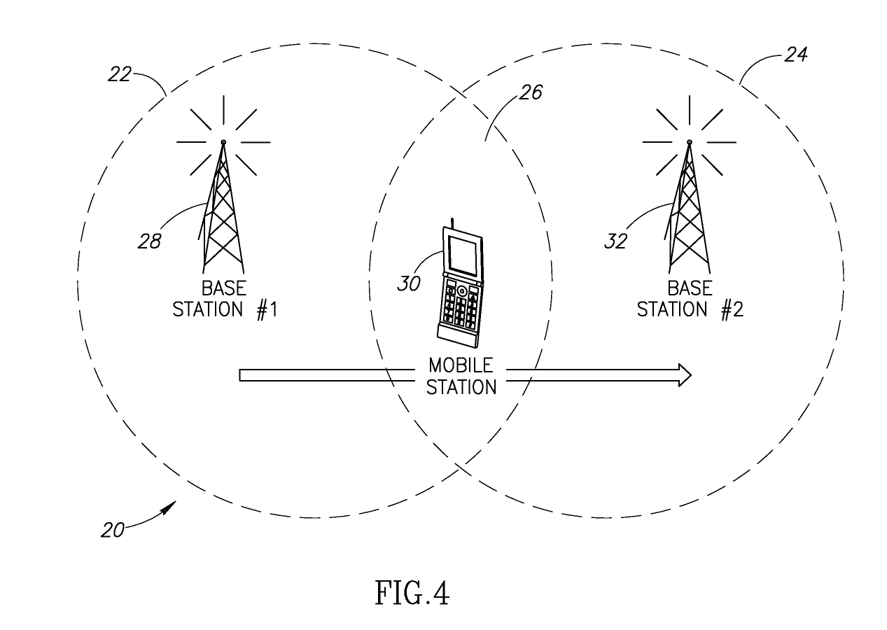

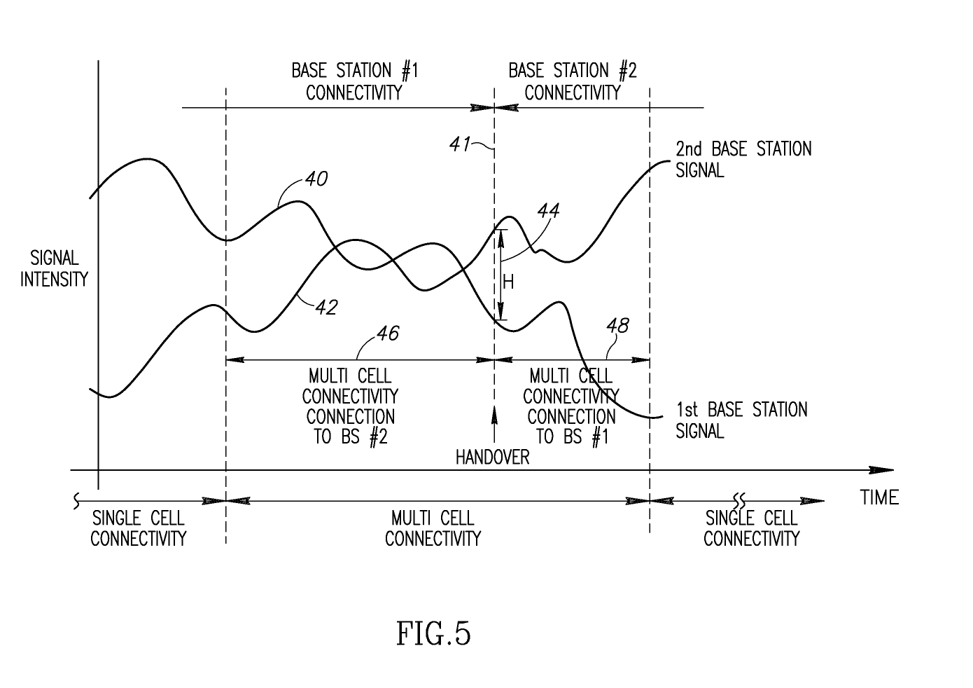

As stated supra, the invention is an autonomous user equipment connectivity mechanism for use in a cellular system (i.e. mobile communications system) internally and between technologies (i.e. inter-RAT). If the user equipment is located in an area where two or more cells overlap in terms of signal strength and or other indicators at the user equipment antenna and reception circuits apparatus, then autonomous user equipment connectivity can take place between the cells using the mechanism of the invention. A diagram illustrating an overview of multi-cell connectivity is shown in FIG. 4. The system, generally referenced 20, comprises two cells 22, 24 comprising base station #1 28 and base station #2 32, respectively, and an overlapping region 26. A diagram illustrating an overview of multi-cell connectivity from a signal intensity perspective is shown in FIG. 5. The signal intensity of base station #1 signal 40 declines while the signal intensity of base station #2 signal 42 is increases as the mobile station 30 passes from cell 22 to cell 24.

With reference to FIGS. 4 and 5, it is in the region where the two cells overlap (i.e. in passing from cell 22 to cell 24) that the mobile station 30 performs the autonomous connectivity mechanism. At some point (dashed line HANDOVER 41) the measurements of the signal strength and/or other parameters cause the connectivity of the mobile station to switch from the base station #1 to base station #2. Outside of the overlapping region 26, the mobile station remains in single cell connectivity. Single cell connectivity of BS #1 is maintained up to the time of handover 41. Similarly, single cell connectivity of BS #2 from the time of handover 41 and beyond.

Within the overlapping region, where the signal strength at the mobile station from both base stations is sufficient, multi-cell connectivity is maintained. Using the autonomous connectivity mechanism, the mobile station optimizes the handover process by improving the selection of the target base station based and optimizing the discontinuity period between SBS disconnect and TBS connect. During period 46, a multi-cell connectivity connection is maintained to BS #2, while connected to BS #1. Similarly, during period 48, a multi-cell connectivity connection is maintained to BS #1, while connected to BS #2.

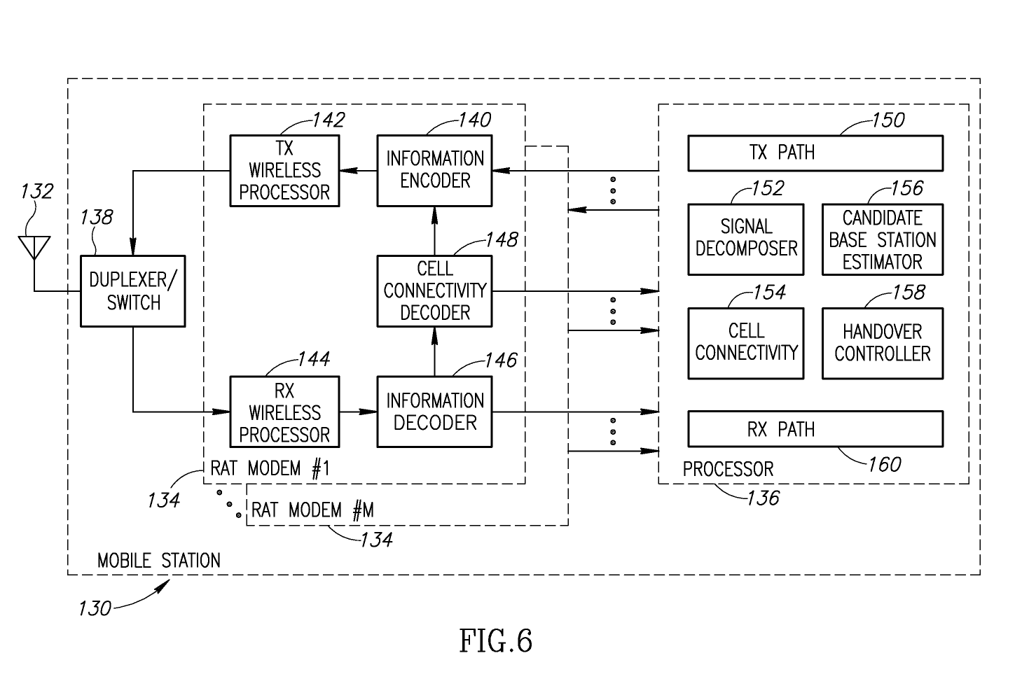

A general block diagram illustrating the multi-cell connectivity user equipment of the present invention is shown in FIG. 6. The mobile station, generally referenced 130, comprises a processor block 136 and a plurality of RAT modem blocks 1 through M. Each modem block is operative to receive and transmit a different radio access technology (RAT). In addition, each modem block 134 is coupled to a corresponding antenna 132 via duplexer/switch 138. Note that for clarity sake, only one switch and antenna are shown. Depending on the implementation, however, the antenna and switch may or may not be shared among the plurality of RAT modems. The modem block comprises an information encoder 140, TX wireless processor 142, RX wireless processor 144, information decoder 146 and cell connectivity decoder 148. The processor block 136 comprises a TX path circuit 150 for providing TX data to the modem, RX path circuit 160 for receiving RX data from the modem, signal decomposer block 152, cell connectivity block 154, candidate base station estimator 15 and handover controller 158.

It is important to note that the scope of the invention is not limited to a single RAT. The invention is suitable for use in systems that have the ability to switch between cells corresponding to different RATs. An MS incorporating the invention and comprising multiple-RAT modems, is able to simultaneously receive information from multiple cells having different RATs and access technologies. Thus, a handover process may involve switching from one RAT to another. In both the multiple-RAT and single RAT cases, the autonomous connectivity mechanism of the invention is operative to improve the reliability of the handover process and reduce the service discontinuity time.

Preferably, the modem comprises a wideband receiver that is capable of receiving multiple RF signals from single or multi-access technologies. The invention incorporating such an RF receiver has applicability in the following cases which utilizes the invention in a complementary manner to implement current and future wireless communication standards. In a first case, cellular technologies which implement the downlink using the same received bandwidth (i.e. single RF, multiple transmission sources) and which enable signal decomposition of SBS and Candidate TBS (CTBS) transmissions will benefit from an improvement in QoS in terms of service continuity or air link connectivity.

In a second case, cellular technologies which support an RF section having wider receive bandwidth than the minimal bandwidth mandated by the particular standard (thus enabling multiple RF reception from signal or multi access technologies) can utilize it to achieve the same.

In a third case, those cellular technologies which utilize the same receive bandwidth as mandated by the particular wireless standard (i.e. single RF, single source) but implement time duplexing may make use of inactivity periods for reception of candidate target base stations without incurring service interruptions.

In a fourth case, those implementations that can utilize standard support requests from the serving base station for absence (inactive) periods (which will prevent data loss but may impact service) will benefit in an improvement in QoS in terms of service continuity or air link connectivity.

The multi-cell receiver enables the mobile station to synchronize to multiple base stations via a downlink only and to a single base station (SBS) via both an uplink and downlink. In operation, the modem transmits and receives signals to/from the serving base station as well as receives signals from multiple target base stations. The signal decomposer 152 (FIG. 6) in the processor 136 is operative to provide the uplink and downlink for the serving base station as well as control and data (i.e. downlink) for the target base stations regardless of the particular RAT or access technology involved.

To enable the mobile station to decode the downlink of several cells concurrently (each base station comprising another cell), each individual cell is identified and synchronized to at both the PHY level and the MAC level via the cell connectivity block 154. The signal decomposer functions to decode protocol date units (PDUs) (i.e. packets, frames, etc.). The mobile station then makes use of MAC level broadcast, multicast or unicast messages and PHY level detection to synchronize to base stations in neighbor cells. For example, PHY level detection of MAC level messages is used to detect the preamble ID in IEEE 802.16 WiMAX messages. It is important to note that implementing autonomous connectivity does not require the decoding of MAC messages, as the information at the PHY is sufficient to perform the methods of the invention as described infra.

Once able to detect and receive MAC messages, the mobile station attempts to decode MAC level PDUs. If the mobile station is able to decode the MAC level PDUs, the base station parameters are then identified and compared against criteria. If the base station parameters are determined to be suitable, the mobile station then identifies the particular base station as a suitable candidate target base station (CTBS). The CTBSs selected are stored in a group or database the contents of which are used in subsequent handover procedures.

Thus, in accordance with the present invention, the mobile station is not required to negotiate for or receive pre-allocated opportunities for measuring parameters of neighbor base stations. The measurement opportunities are created and managed by the mobile station itself in an autonomous manner in accordance with instantaneous activity patterns and the particular wireless standard protocol implemented.

Normally, networks allocate a measurement opportunity to the mobile station. The measurement opportunity can be either explicit or implicit as function of the protocol. For example, in WiMAX, an explicit allocation opportunity follows negotiation. In GSM, an implicit allocation assumes a specific time slot at each frame is used for this purpose. An idle frame inserted every 13 frames can be used for measurements that require more than half a time slot. In most cases, the allocation of the measurement opportunity is negotiation based.

Further, prior art mobile stations measure neighbor cells using only the measurement opportunities provided by the protocol. If there is need to decode data from a base station other than the serving base station, the mobile station must explicitly request an inactivity period.

These measurement opportunities are used by the mobile station to measure parameters. Using these parameters, the mobile station builds and maintains a database of neighbor cells that contain both relevant and irrelevant candidates for HO. The parameter set that is tracked preferably comprises the complete set of parameters that can be measured without any assistance from the base station, especially those that can affect the handover process. The target base station parameters measured or acquired may include, for example, received signal quality, synchronization information (in frequency and time), network/operator ID, cell type (i.e. macro, micro or pico) and service capabilities (e.g., current load).

Example parameter sets that may be used for the measurement opportunities the results of which are used to build and maintain a database of neighbor cells is described below. It is appreciated by those skilled in the art, that zero or more of these parameters sets and any number of parameters within each set may be used and in any combination.

The first set comprises parameters whose values are derived from intra-frequency measurements carried out by intra-frequency measuring means on the estimated channel that extends between the BS and the corresponding MS. Optional parameters include: Channel Quality Indicators (CQI), Carrier to Interferences and Noise Ratio (CINR) mean, CINR standard deviation, Received Signal Strength (RSS) mean, RSS standard deviation, timing adjustment, offset frequency adjustment, optimal transmission profile, and the like, and any combination thereof.

A second set comprises parameters whose values are derived from inter-frequency measurements carried out by inter-frequency measuring means on channels other than the estimated channel. Such optional parameters include: CQI, CINR mean, CINR standard deviation, RSSI mean, RSSI standard deviation, timing adjustment, offset frequency adjustment, optimal transmission profile, etc. and any combination thereof.

A third set comprises parameters whose values are derived from intersystem measurements carried out by intersystem measuring means. Such optional parameters include: current transmit power, maximum transmit power, power headroom, internal measurements on the equipment, etc. and any combination thereof.

A fourth set comprises parameters that relate to MS positioning measurements carried out by positioning measuring means. Examples of such parameters include: position indication using GPS or other triangular systems, time offset (propagation time), propagation loss, etc.

A fifth set comprises parameters relate to measurements of the traffic volume carried out by traffic volume measuring means. Examples of such parameters include the amount of transmission units (bit, packet, burst of packets, frames, blocks, etc.) transmitted successfully/failed, for every link, connection, session, etc. existing or in holding between the managing and managed entities.

A sixth set comprises parameters that relate to measurements of the quality of the link carried out by link quality measuring means. Examples of such parameters include: Traffic Peak Rate/PIR with the time base for calculation, traffic rate deviation, latency, jitter, loss ratio, CIR fulfillment, voice quality, grade of service indications, BER, PER, BLER, network Key Performance Indicators (KPI), the amount of time the terminal received information in certain quality during a certain time period, information associated with connection switching, etc.

Measuring and acquiring these parameters before the handover process (when required) permits a significant reduction (and possible elimination) in switching time since the candidate target base station downlink connectivity has already been established and target cell support parameters and status are already known. The continuous tracking of multiple TBSs, permits a significant improvement in hardware switching time since the MS does need to acquire and/or measure parameters to obtain the information required to make handover decisions, as the MS has already obtained the necessary information.

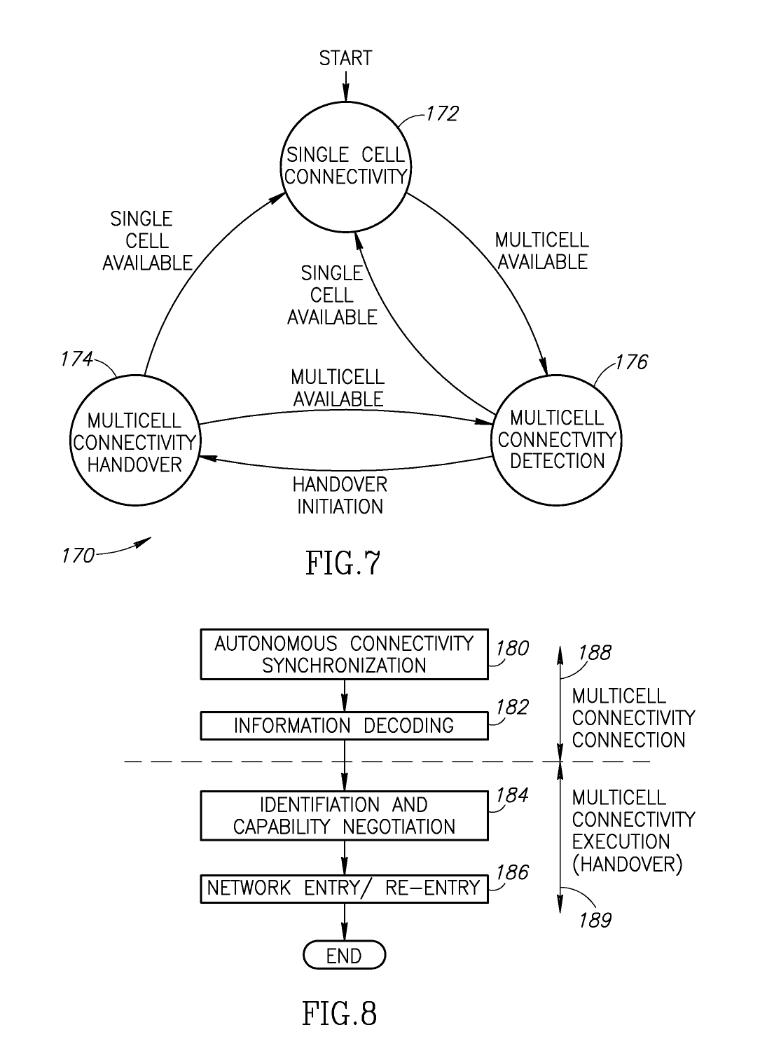

A state diagram illustrating the multi-cell connectivity user equipment state machine is shown in FIG. 7. The machine, generally referenced 170, comprises a signal cell connectivity state 172, multi-cell connectivity discovery and detection state 176 and a multi-cell connectivity handover state 174. Operation begins in the single cell connectivity state. If multi-cell connectivity is detected while in state 172 or state 174, the machine transitions to state 176. While in state 176, a handover initiation causes a transition to state 174. The availability of single cell connectivity while in state 176 or state 174 causes a transition to state 172.

A diagram illustrating autonomous connectivity state functionality is shown in FIG. 8. In a multi-cell connectivity stage 188, the mobile station synchronizes with the serving base station and with multiple target base stations and receives PHY and possibly MAC level information (step 180). The MS then decodes the downlink (DL) information received from the TBSs (step 182). In a handover preparation stage (i.e. multi-cell connectivity execution stage) 189, the MS performs identification and capability negotiation (step 184) between the mobile station and the target base stations, selects a TBS and establishes network connectivity to the selected TBS. The network then connects/re-connects to the new TBS (step 186).

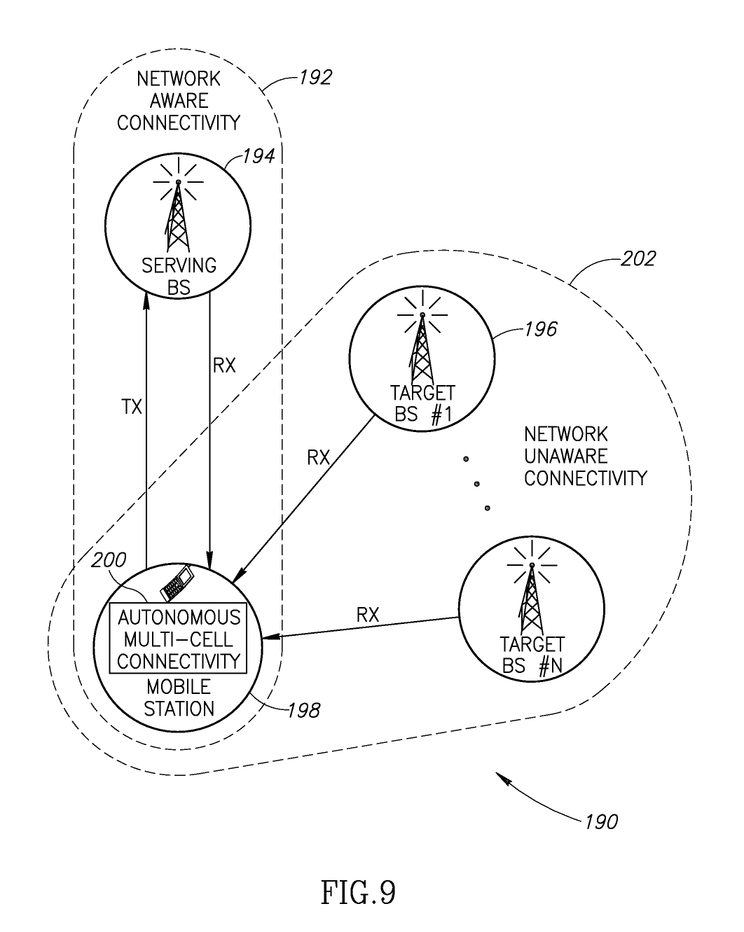

A diagram illustrating the multi-cell connectivity from the mobile station to the network in accordance with the present invention is shown in FIG. 9. The example network, generally referenced 190, comprises a mobile station 198 that maintains both network aware connectivity 192 and network unaware connectivity 202. The mobile station incorporates the autonomous multi-cell connectivity mechanism 200 of the present invention and is synchronized, registered with and maintains both uplink (UL) and downlink (DL) connections to a serving base station 194. This connection constitutes the network aware connectivity portion 192.

In accordance with the invention, the network unaware connectivity portion 202 is also maintained by the mobile station wherein one or more candidate target base stations (CTBSs) 196, labeled target base station 1 through N, are connected via downlinks only to the mobile station. The mobile station is connected to the target base stations to acquire parameters before a handover in order to reduce handover switching latency. Note that the mobile station is connected to the multiple base stations (CTBSs) via downlinks while maintaining full connectivity (i.e. DL and UL) with a single serving base station. The SBS is aware of the connectivity with the mobile station and thus it maintains network aware connectivity. In accordance with the invention, the CTBSs (TBS 1 to TBS N) are unaware of the connectivity to the mobile station as all parameters for this connectivity where obtained without any network support for the mobile station.

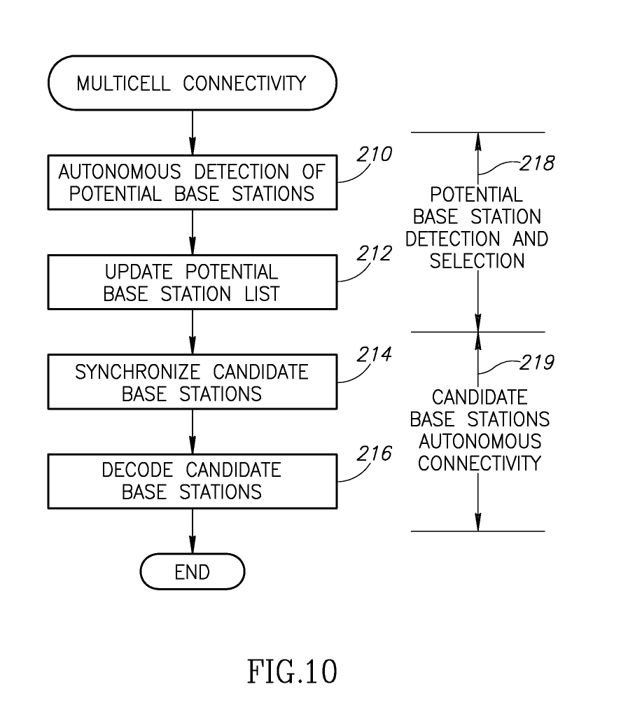

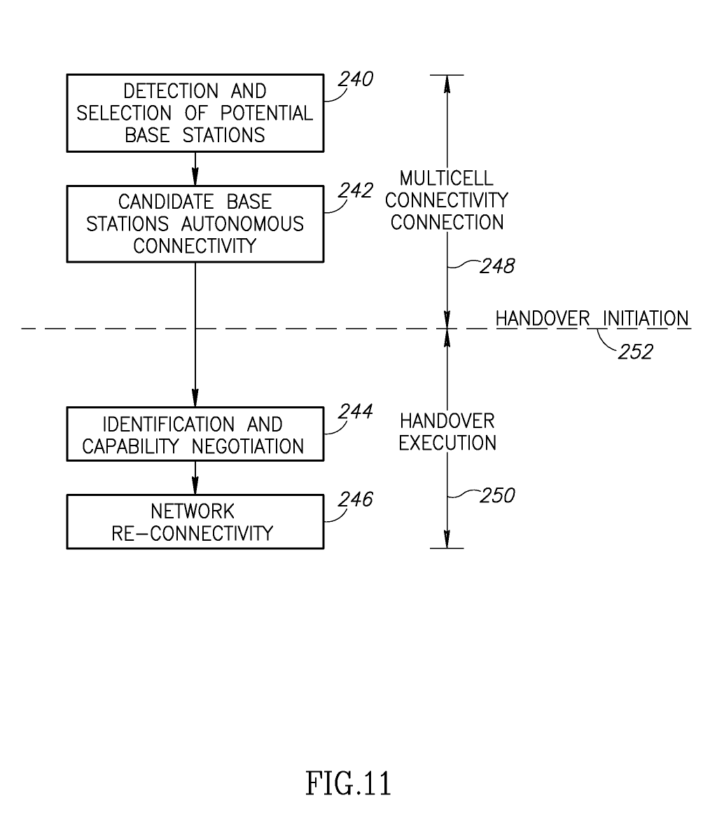

A diagram illustrating multi-cell connectivity discovery and detection state functionality (at the HO preparations stage) is shown in FIG. 10. The mobile station first detects and selects potential target base stations (218). This includes autonomous discovery and detection of potential base stations (step 210) and updating a potential base station list that is maintained by the mobile station (step 212). The mobile station then connects autonomously to each candidate base station (219). This includes synchronizing with candidate base stations (step 214) and decoding candidate base stations (step 216).

Note that in synchronizing to a base station, the user equipment obtains at least a basic set of reception parameters such as time, frequency and identity, for example. Note further that synchronization may occur in band (i.e. the base station is in the same channel) or out of band (i.e. the base station is in a different channel) in the same or different RAT or access technologies.

Note also that target base station information decoding involves the decoding of neighbor base station DL broadcast messages and the acquisition of parameters for identifying base station capabilities, base station network identity (e.g., MAC address in IEEE 802.16 networks or BCH in GSM networks), MAPs of resources, connection allocations, etc. Note further that synchronization and target base station information decoding can be performed (1) continuously in parallel to decoding the information from the serving base station or (2) during time gaps between information decoding.

During the autonomous connectivity stage, the mobile station autonomously scans (i.e. searches) for candidate target base stations (CTBSs) based on its knowledge of the particular wireless protocol in use. Note that the process of scanning for CTBSs may be performed by the mobile station autonomously or can be performed based on information provided by the serving base station, possibly without any prior knowledge of the particular access technique. The scanning may be performed in one of several ways. It can be a continuous, periodic, mobile station triggered or network triggered process. In addition, the mobile station may use advertising parameters obtained from neighboring network base stations to scan for CTBSs.

The parameters (either measured or acquired) of each CTBS are checked against a criteria (e.g., signal strength above a certain level). The mobile station creates and maintains a candidate target base station list (database or scan set) of candidate target base stations that meet the particular criteria. Based on the scan results (both previous and current), the scan set created defines a set of autonomous CTBSs comprising the target base stations to which the mobile station autonomously connects.

In autonomous connectivity to the CTBSs the mobile station maintains a connection to several CTBSs simultaneously. This connectivity enables the mobile station to acquire the CTBS parameters (e.g., synchronization, decoding, network/operator IDs, cell type, etc.) which will be used in handover operations to provide zero or near zero switching times to the CTBS selected to be the new serving base station. Note that the mobile station may at this stage decode the CTBS information simultaneously with that of the serving base station.

In a handover, one of the target base stations is selected as a candidate to be the new serving base station. Although the target base station chosen will typically be found in the candidate target base station list generated previously, it may not be.

The mobile station verifies the connectivity to the target base station. Note that verification only is required, since the mobile station is already autonomously connected to the target base station. Using the autonomous connectivity procedure, the mobile station only needs to complete the uplink connection to the selected target base station and establish network connectivity. The target base station now functions as the serving base station.

A diagram illustrating handover preparation and execution flow with the multi-cell connectivity mechanism of the present invention is shown in FIG. 11. During the multi-cell connectivity connection (248), the mechanism dynamically detects and selects candidate base stations and places them into a candidate base station list (step 240). The candidate base station list may be a subset of a larger list of known base stations. The list represents the current set of base stations that are slated for controlled and/or autonomous monitoring and tracking. In other words, the list represents the potential candidates that are handover worthy at a specific point in time. Note that in signaling discovery and detection, control and data information bits are detected. Further, the discovery and detection is performed autonomously in accordance with the particular wireless standard in use.

The base stations in the candidate base station list are dynamically ranked according to predefined criteria, current measurements and information stored in the user equipment memory (see processor 136, FIG. 6). In accordance with the invention, the new measurements are performed in an autonomous manner, that is, without any specific commands or instruction from the network or the serving base station in all or a portion of the related parameters or dimensions, including schedule, target base station and type of measurement (step 242). The process of discovering, detecting and decoding is described in more detail infra.

Once handover is initiated (dashed line 252) by the MS using TBS monitoring or via other network elements, handover execution (250) includes identification and capability negotiation between the mobile station and the candidate target base station that has been chosen as the target base station (step 244). Network re-connectivity to the target base station is then performed (step 246), however at higher efficiency and flexibility.

Note that autonomous multi-cell connectivity between cells takes place when the user equipment is located in a region where two or more cells overlap in terms of both signal strength and signal quality at the antenna of the user equipment. During autonomous user equipment connectivity, user equipment is in communication (from network point of view) with or registers with a serving base station. While in parallel, the user equipment is operative to concurrently detect several additional candidate base stations. The autonomous user equipment connectivity functions to effectively accelerate what would normally be a “controlled” (i.e. original) handover. Further, by taking advantage of the coverage in overlapping cell regions, handover is performed in a much more efferent manner thereby decreasing the time for the user equipment to move from one cell to another.

As opposed to prior art user equipment connectivity techniques, where the selection of a base station for handover is done based on commands and support information received from the serving base station, the mechanism of the present invention accelerates the handover process, and in particular, the period of unavailability between (1) session closure at the serving base station and (2) connecting, registering and opening a session with the selected target base station which after completion of the handover process becomes the new serving base station. It is important to note that use of the mechanism of the present invention increases the probability of successfully connecting to the TBS. This is because up to the point of handover, the MS has been continuously monitoring and maintaining connectivity with the TBS and maintains up to date and continuous information regarding the link, etc. This reduces the probability that a connection to the TBS at the time of handover will be unsuccessful for failure to establish the link.

Thus, in accordance with the mechanism of the invention, potential base stations are detected and sets of candidate base stations are selected and placed on a candidate base station list for use during autonomous user equipment connectivity without the need for sending and receiving network advertising information and handover control messages. The discovery and detection and selection steps are performed autonomously by the user equipment. An important aspect of the invention is that the autonomous connectivity scheme does not require coordination between the serving base stations.

In accordance with the invention, the user equipment does not negotiate for or receive pre-allocated opportunities from the network to measure neighbor base stations. Further, measurement opportunities are created by the user equipment autonomously in accordance with current activity patterns, thereby eliminating any bandwidth waste. The measurement opportunities are used by the user equipment to measure and maintain the database of candidate target base stations (i.e. neighboring cells), wherein the parameter set that is tracked includes those parameters that (1) can be measured without any assistance from the target base station and (2) may effect the handover process. Example target base station parameters include, but are not limited to, (1) received signal quality, (2) synchronization information (i.e. frequency and time), (3) network/operator ID, (4) cell type (i.e. macro/micro/pico), (5) service capabilities (e.g., current load), etc., (6) any or all of the parameters and parameter sets described supra. It is appreciated that the user equipment may detect other parameters or metrics as well by measurement or by other means.

Depending on the implementation, the selection of the candidate base stations may be based on any number of the following parameters: link level measurements, link quality measurements, quality of service and other parameters and criteria, either measured or stored in user equipment memory such as any or all of the parameters or parameter sets described supra, e.g., CQI, CINR mean, CINR standard deviation, RSS mean, RSS standard deviation, timing adjustment, offset frequency adjustment, optimal transmission profile, current transmit power, required transmit power, required power headroom; parameters which relate to the managed entity positioning measurements such as position indication using GPS or other triangular systems, time offset, propagation time, propagation loss, amount or transmission unit (bit, packet, burst of packets, frame, blocks, etc.) transmitted successfully/failed, for every link, connection, session, etc. extending or held between the managing and managed entities; measurements of the quality of the link such as Traffic Peak Rate/Peak Information Rate (PIR) with time base for calculation, traffic rate deviation, latency, jitter, loss ratio, Committed Information Rate (CIR) fulfillment, voice quality, grade of service indications, BER (bit error rate), PER (packet error rate), BlER (Block error rate), network KPI (Key Performance Indicators), etc.

Note that the handover process can be made more effective by selecting an active base station based on a measure of the end-to-end quality of service from the base station to the destination user equipment thereby making it possible to select base stations to add to the candidate base station list based on the best overall end-to-end performance to the destination user equipment.

The mechanism further comprises choosing a candidate base station using threshold values determined by the mechanism internally or by other network elements directly (via proprietary or non-proprietary messaging, based on the measure of the link level and quality of service of the candidate base station or on any other parameters such as those described supra. These threshold values are then used at the initiation of the handover process by the user equipment. Note that this provides a convenient mechanism for allowing the user equipment to select the target base station and optimize the handover timing. For example, the threshold values may be based on at least one of the following relative measures: RSSI, BER estimation, motion estimation, modulation and coding scheme, etc.

Preferably, a base station is selected as a candidate base station based also on a measure of radio channel conditions from a user equipment to the particular base station. This permits a base station with good quality radio channel conditions to be selected in preference to a base station with poor radio conditions. In addition, the user equipment dynamically ranks the base stations in the candidate target base station list in accordance with (1) the radio link quality associated with each base station, (2) an estimate of the overall performance in accordance with a predetermined criteria or based on any combination of parameters or parameter sets described supra.

The user equipment selects a candidate base station from the list based also on radio channel past conditions or based on a parallel discovery and detection mechanism. The discovery and detection mechanism in the user equipment attempts to identify the operating system by classifying them into a relevant radio access technology (RAT). This is achieved by analyzing receive energy or traffic/signaling frames utilized in the operating (i.e. connected) frequency band and in other frequency bands in parallel with normal communications with the serving base station (i.e. transmitted and received information). In the case of WiMAX (i.e. 802.16e radio access technology), for example, the user equipment may detect (i.e. measure) the following signaling elements: preambles, PRBS, PHS and MAPs.

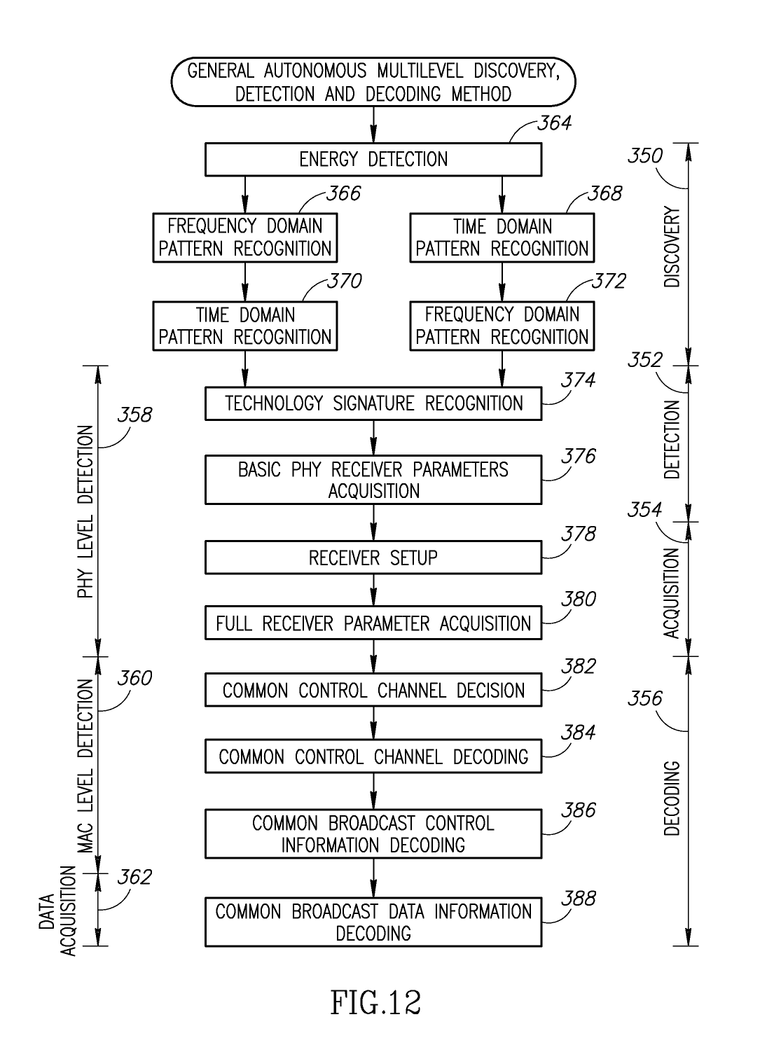

The general multilevel discovery, detection and decoding method of the present invention will now be described in more detail. A flow diagram illustrating the general multilevel discovery, detection and decoding method of the present invention is shown in FIG. 12. The method is divided into a plurality of stages or phases, namely discovery 350, detection 352, acquisition 354 and decoding 356. PHY level detection 358 encompasses the detection 352 and acquisition 354 stages. MAC level detection 360 and data acquisition 362 encompass the decoding stage 356.

Initially, the MS first detects energy at the appropriate frequency via one or more of the modems 134 (FIG. 6) (step 364). Patter recognition on the detected energy is performed in the frequency domain (step 366) followed by time domain pattern recognition (step 370). To increase discoverability, the order of pattern recognition is reversed with time domain patter recognition performed (step 368) followed by frequency domain pattern recognition (step 372).

The signals received are matched against known signatures of the various RAT or access technologies (step 374). Using this technique, the basic PHY receiver parameters are acquired (step 376). Based on the receiver parameters acquired, the receiver is then setup (step 378) to permit a full receiver parameter acquisition (step 380). This constitutes the PHY level detection stage 358.

In the MAC level detection stage 360, common control channel decisions are made (step 382) decoding of the common control channel is performed (step 384). Further, common broadcast control information is decoded as well (step 386). Once the common broadcast channel control information is decoded, common broadcast data information can be decoded (step 388).

It is important to note that this process of discovery, detection and decoding help to greatly reduce the overhead of the link since (1) the SBS does not need to send control commands to the MS to scan for TBSs and (2) the MS does not need to send associated reports to the SBS. Performing PHY level detection on multiple TBSs help in decoding broadcast control and data information from candidate TBSs.

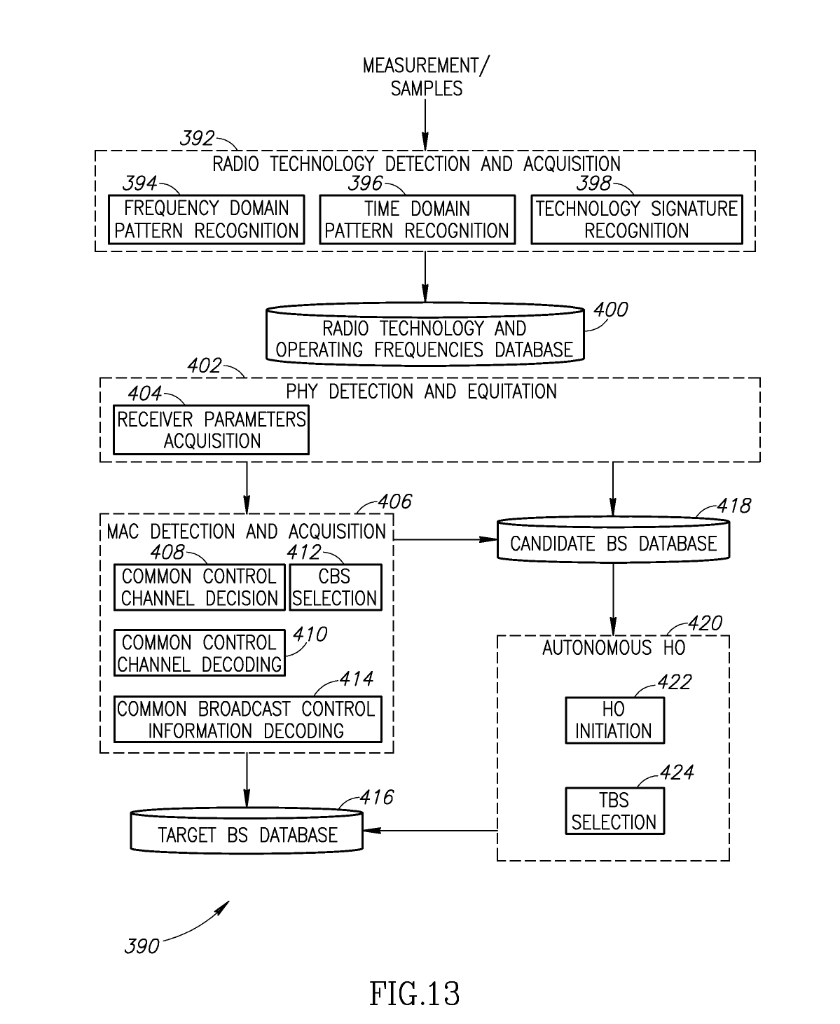

A diagram illustrating the candidate base station selection and handover initiation process is shown in FIG. 13. This process depends on the parameter measurements and samples obtained using the discovery, detection and decoding method of FIG. 12. The process, generally referenced 390, comprises a RAT detection and acquisition block into which the measurements/samples are input. The RAT detection and equalization block comprises frequency domain patter recognition block 394, time domain patter recognition block 396 and technology signature recognition block 398. The results of the recognition functions are stored in a RAT and operating frequencies database 400.

The data stored in the RAT and operating frequencies database 400 are used by the PHY detection block 402 to acquire one or more receiver parameters via receiver parameter acquisition block 404. These parameters are stored in the candidate BS data base 418 and input to the MAC detection block 406. The MAC detection block 406 uses the receiver parameters acquired in generating common control channel decisions (block 408), selecting one or more Candidate Base Stations (CBSs) (block 412), performing common control channel decoding (block 410) and common broadcast control information decoding (block 414). The results of the MAC detection block 406 are stored in a Target BS database 416 and the Candidate BS database 418.

An autonomous handover block 420 functions to perform handover initiation (block 422) and selection of the TBS from amongst the Candidate BSs (block 424). The results from the autonomous handover block processing are stored in the target base station database 416.

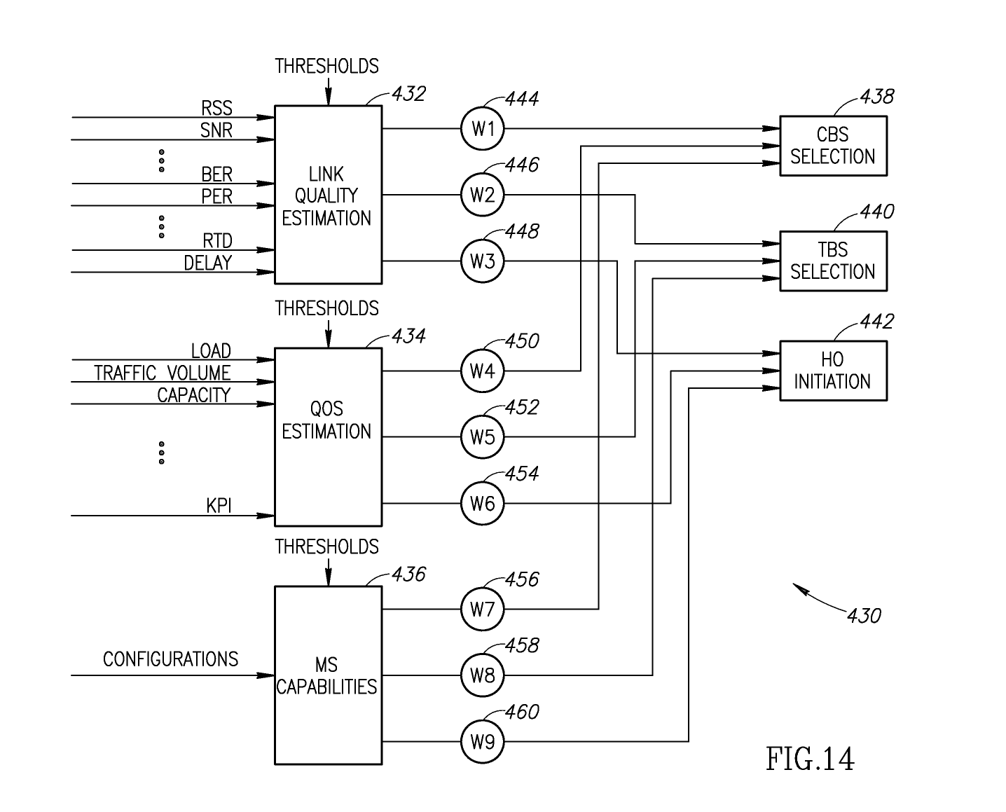

A diagram illustrating and example mechanism for TBS and CBS selection and handover initiation is shown in FIG. 14. This block diagram shows an example process, generally referenced 430, of selecting the candidate base station, target base station and performing HO initiation all of which utilize output from a link quality estimation block 432, QoS estimation block 434 and MS capabilities block 436 in their determination processes.

The link quality estimation block 432 takes as input a plurality of link quality related parameters such as RSS, SNR, PER, RTD, Delay, etc. as described supra. Based on one or more input thresholds, the block outputs estimates of the link quality between the MS and one or more base stations. Each of the link quality estimates is weighted via weights W1 444, W2 446, W3 448 before being input to each of the selection and initiation blocks 438, 440, 442, respectively.

The QoS estimation block 434 takes as input a plurality of QoS related parameters such as Load, traffic volume, capabilities, KPI, etc. as described supra. Based on or more input thresholds, the block outputs QoS estimates of the link between the MS and one or more base stations. Each of the QoS estimates is weighted via weights W4 450, W5 452, W6 454 before being input to each of the selection and initiation blocks 438, 440, 442, respectively.

The MS capabilities block 436 takes as input a plurality of configuration information. Based on or more input thresholds, the block outputs capability information wherein each of the MS capability estimates is weighted via weights W7 456, W8 458, W9 460 before being input to each of the selection and initiation blocks 438, 440, 442, respectively.

### Multi-Cell Connectivity

### WiMAX Example

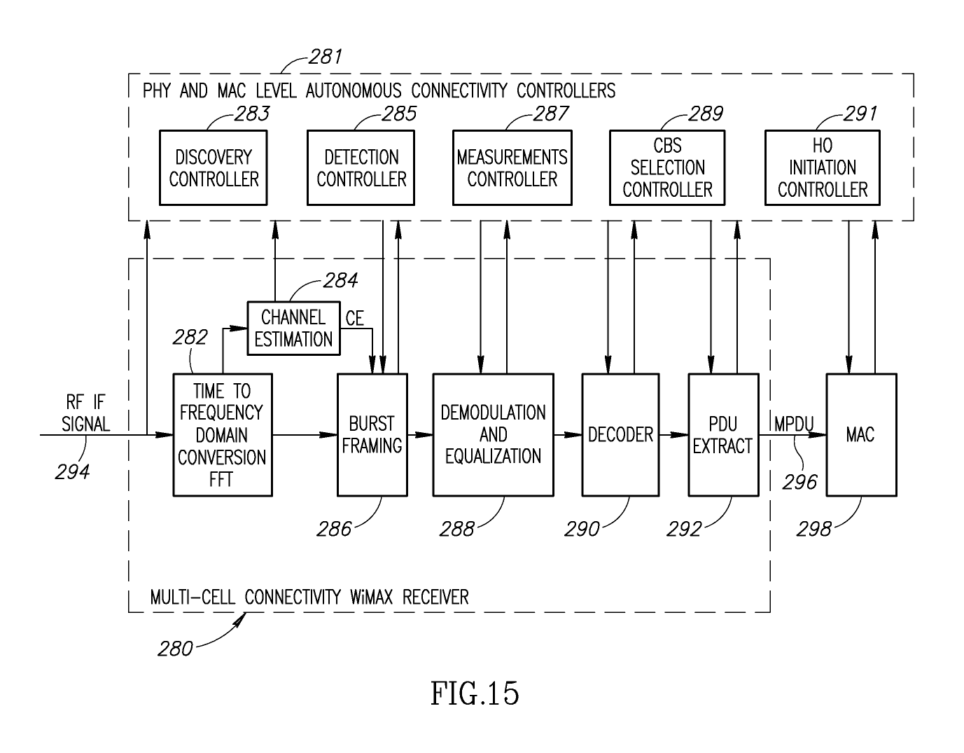

An example of the multi-cell connectivity mechanism of the present invention adapted for use with the IEEE 802.16 WiMAX standard will now be presented. A block diagram illustrating an example multi-cell connectivity WiMAX receiver constructed in accordance with the present invention is shown in FIG. 15. Note that for clarity sake, only the relevant portions of the receiver are shown. The multi-cell connectivity WiMAX receiver, generally referenced 280, comprises a time to frequency domain conversion block 282 adapted to receive an RF intermediate frequency (IF) signal 294, channel estimation 284, burst framing block 286, demodulation and equalization block 288, decoder 290 and PDU extract block 292 operative to output MAC PDUs (MPDUs) 296 to MAC 298. In accordance with the invention, the receiver 280 also comprises PHY and MAC level autonomous connectivity controllers 281 comprising a discovery controller 283, detection controller 285, measurements controller 287, CBS selection controller 289 and HO initiation controller 291 which are in communication with the receiver 260 elements and the MAC. The PHY and MAC level autonomous connectivity controller perform the mechanisms of the present invention as described in detail supra.

In operation, a sampled discrete baseband RF signal (294) composed of both the SBS and TBS(s) is received from the RF front end (not shown) and input to the time to frequency domain converter (FFT) (282) where it is converted to a frequency discrete signal. The frequency discrete signal is input to the channel estimation block (284) which functions to perform channel estimation for each source, based on the preamble series and pilots PRBS from each source (i.e. SBS or TBS). The channel estimation (CE) is input to the burst framing block (286) which functions to perform the transition from the frequency domain to the logical channel domain which, together with the CE results, converts the received signal from a composed form to a separate signal for the SBS and each TBS. These signals are then decoded (block 290) and the PDUs extracted (block 292). The MAC PDUs are sent to the MAC 298 for MAC level processing.

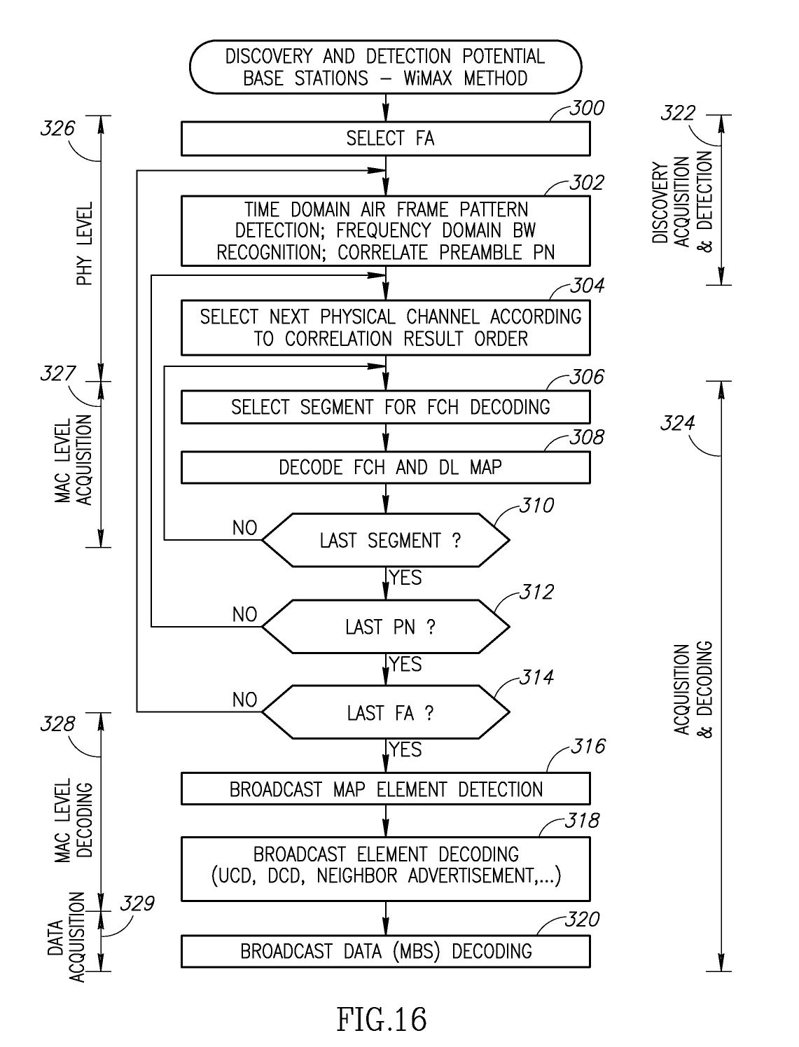

A flow diagram illustrating a multilevel method for the discovery, detection and decoding of candidate base stations for WiMAX networks is shown in FIG. 16. The method is divided into a plurality of stages or phases including discovery, acquisition and detection 322, acquisition and decoding 324, PHY level acquisition 326, MAC level acquisition 327, MAC level decoding 328 and data acquisition 329.

First, the foreign agent (FA) is selected (step 300). A foreign agent stores information about mobile nodes visiting its network and also advertises care-of addresses. Next, time domain air frame patter detection, frequency domain bandwidth recognition and preamble PN correlation are performed (step 302). Note that in this step, all 114 possible preamble pseudo noise (PN) sequences are correlated and ordered in accordance with the correlation results. The next physical channel to scan is selected in accordance with the ordering of the correlation results (step 304). A segment is then selected for decoding of its frame control header (FCH) (step 306). The FCH and downlink medium access protocol (DL-MAP) fields are decoded (step 308). The above steps are repeated in three nested loops for each segment (step 310), PN sequence (step 312) and foreign agent (step 314).

Immediately after the downlink preamble, each downlink frame comprises a Frame Control Header (FCH) which is sent at the lowest modulation and coding rate to ensure all subscriber stations in the coverage cell can receive it. The FCH is used to describe one or more separate broadcast bursts of payload data in the downlink frame. Examples of data that may be in the first broadcast burst; includes, maps, burst profile descriptions (UCD, DCD), grant allocations for initial ranging, grant allocations for contention bandwidth requests, etc.

The DL-MAP field provides information on the DL burst allocation and PHY layer control and management messages (e.g., information elements or IEs). It is inserted in the first broadcast burst following the FCH field to describe other bursts that follow the FCH broadcast burst.

Once a candidate target base stations has been found and the FCH and DL-MAP fields have been decoded, the broadcast MAP elements are detected (step 316). This includes detecting the capabilities and broadcast parameters of the target base station. Once detected, the broadcast elements are then decoded (step 318). Example broadcast elements include, for example, Downlink Channel Descriptor (DCD) messages and Uplink Channel Descriptor (UCD) messages. The base station inserts a Downlink Channel Descriptor (DCD) and/or an Uplink Channel Descriptor (UCD) message after any downlink and uplink maps in the first broadcast burst. The purpose of the DCD/UCD is to define downlink/uplink burst profiles specifying parameters such as modulation type, FEC, scrambler seed, cyclic prefix, and transmit diversity type. Once defined, burst profiles are referred to in later downlink maps via a numerical index called the Downlink Interval Usage Code (DIUC) or Uplink Interval Usage Code (UIUC), which is associated with the profile.

Broadcast data (MBS) is then decoded (step 320), e.g., mobile neighbor advertisement (NBR-ADV) messages. Mobile neighbor advertisement messages provide information into the available neighboring base stations for use in considering cell selection.

Additional parameters and information are obtained by decoding other messages on the broadcast connection ID (CID). The 16-bit connection ID (CID) field defines the connection that the particular packet is servicing. Each connection is identified a unique CID. Since connections are unidirectional, two CIDs are used in a bidirectional link.

### Multi-Cell Connectivity

### GSM Example

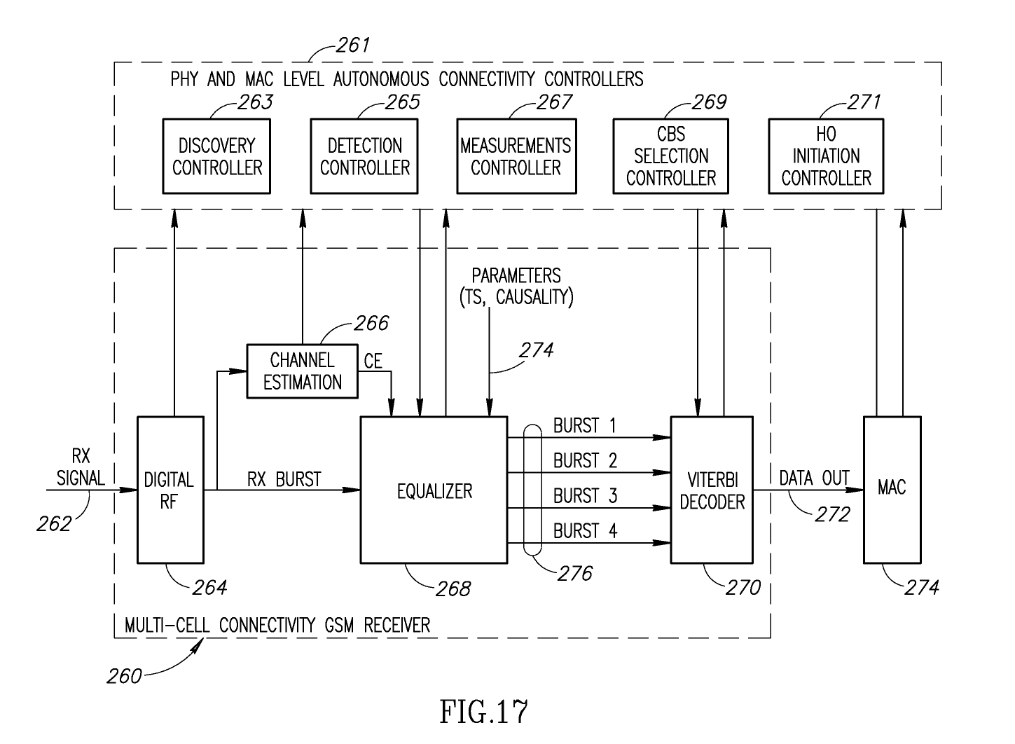

An example of the multi-cell connectivity mechanism of the present invention adapted for use with the GSM standard will now be presented. A block diagram illustrating an example multi-cell connectivity GSM receiver constructed in accordance with the present invention is shown in FIG. 17. Note that for clarity sake, only the relevant portions of receiver are shown. The multi-cell connectivity GSM receiver, generally referenced 260, comprises a digital RF block 264 operative to receive a RX signal 262, channel estimation block 266, equalizer 268 and Viterbi decoder 270 operative to output the receive data 272 to MAC 274. In accordance with the invention, the receiver 260 also comprises PHY and MAC level autonomous connectivity controllers 261 comprising a discovery controller 263, detection controller 265, measurements controller 267, CBS selection controller 269 and HO initiation controller 271 which are in communication with the receiver 260 elements and the MAC. The PHY and MAC level autonomous connectivity controller perform the mechanisms of the present invention as described in detail supra.

In operation, a receive RF signal 262 is received by the digital RF block 264. The receive RF signal comprises both the SBS and TBS(s) transmitted signals. The digital RF block 264 functions to converts the analog RF signal to discrete signals i.e. samples. The discrete signal passes to the channel estimator (block 266) which, based on their respective Training Sequence (TS), performs a channel estimation for the SBS and the TBS(s). The discrete signal and CE are input to equalizer 268 and using the SBS TS parameters 274 and channel estimates (CEs), the equalizer functions to remove the TBS signal perceived by the receiver as an interferer. This operation is similarly performed by the equalizer over the combined signal using the TBS channel estimate and TBS TS 274. After reception of four bursts 276 for either SBS or TBS(s) the four bursts are input to the Viterbi decoder 270 which performs the channel decoding operation (i.e. forward error correction or FEC decoder), interleaving and de-puncturing operations. Once these operations are complete, the resulting data block is transferred to the MAC 274 for MAC level processing.

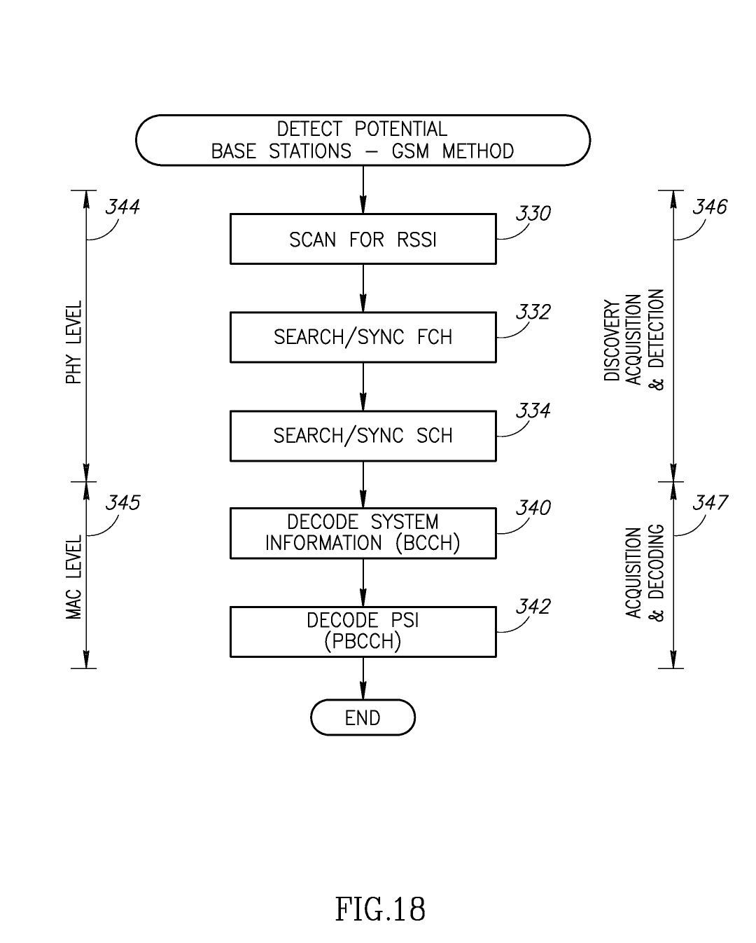

A flow diagram illustrating a multilevel discovery, detection and decoding method of candidate base stations for GSM networks is shown in FIG. 18. The method is divided into a plurality of states or phases including discovery, acquisition and detection 346, acquisition and decoding 347, PHY level 344 and MAC level 345. To find neighbor base stations, the receiver first scans GSM channels measuring receive signal strength indication (RSSI) values at each channel (step 330). The acceptable channels each represent a target base station and as a group comprise the scan set of CTBSs. For those channels in the Once the channels are identified, a search is made for the frequency correction burst (FCH) transmitted by the base station (step 332). A search is also made for the synchronization burst (SCH) transmitted by the base station (step 334).

Wireless communication systems such as GSM use a combination of Frequency Division Multiple Access (FDMA) and Time Division Multiple Access (TDMA) to provide access to multiple users. In FDMA/TDMA-based systems, frequency and timing synchronization between the receiver and transmitter is required before communications can occur. The GSM standard provides a frequency correction burst (FCH burst) for frequency synchronization, and a synchronization burst (SCH burst) for timing synchronization in the Broadcast Control Channel (BCCH) carrier. The FCH burst is required to achieve frequency synchronization. Typical FCH detection methods exploit the narrow-band nature of the FCH burst. One method uses a bandpass filter of constant bandwidth, centered at the expected frequency of the FCH burst. Another uses the correlation between the received signal and a reference signal selected depending on the expected frequency of the FCH burst.

Once the FCH and SCH bursts are used to achieve synchronization and timing, system information as conveyed in the BCCH message can be decoded (step 340). Each base station transmits information about its cell on a broadcast control channel of its own, to which all mobile stations in the area of the cell listen. The BCCH of a base station continuously sends out identifying information about its cell site, such as its network identity, the area code for the current location, whether frequency hopping and information on surrounding cells. The BCCH downlink channel contains specific parameters needed by a mobile station identify the network and gain access to it. Typical information in the BCCH comprises the Location Area Code (LAC), the Routing Area Code (RAC), the Mobile Network Code (MNC) and the BCCH Allocation (BA) list. Once homed in on the Broadcast Control Channel the mobile station monitors the data stream transmitted by the base station looking for a frequency control channel burst (FCCB). The mobile uses the Frequency Correction Channel (FCCH) to synchronize itself with the GSM framing.

With reference to GPRS systems, once the BCCH system information is decoded, packet system information (PSI) is then decoded on the packet switched broadcast control channel (PBCCH) if it exists (step 342). If a mobile station is in packet transfer mode, packet system information (PSI) messages are transmitted on the PBCCH channel from the network to the mobile station. Using the PSI messages decoded from the PBCCH channel, the mobile station can determine whether a packet data link can be set up in the cell and also what parameters it needs to set up and operate the connection in the cell. Once these messages are found and decoded for a target base station, the mobile station can establish a DL connection.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for use on a mobile station connected to a network, said method comprising the steps of:
selecting a set of one or more candidate target base stations;
performing autonomous signaling discovery and detection on said set of one or more candidate target base stations over the same or across a plurality of access technologies; and
updating said selection based on measurements obtained via said autonomous signaling discovery and detection.

2. The method according to claim 1, wherein said autonomous signaling discovery and detection is performed without any negotiation with the network.

3. The method according to claim 1, further comprising the step of completing a handover process utilizing said measurements to update a candidate target base station database.

4. The method according to claim 1, further comprising the step of assisting a network initiated handover decision by providing a candidate target base station database thereto.

5. The method according to claim 1, wherein said candidate base stations are selected based on one or more measured parameters or criteria on any target base station physical channel.

6. The method according to claim 5, wherein said one or more parameters comprises link level, link quality and received signal quality.

7. The method according to claim 5, wherein said one or more parameters comprises end-to-end quality of service.

8. The method according to claim 5, wherein said one or more parameters comprises any parameters able to be measured without assistance from a target base station.

9. The method according to claim 5, wherein said one or more parameters comprises any parameters that can potentially effect the handover process.

10. The method according to claim 1, wherein said step of performing autonomous signaling discovery and detection is performed while maintaining connectivity to a serving base station.

11. The method according to claim 1, wherein signaling discovery and detection measurement opportunities are created autonomously in accordance with instantaneous activity patterns of target base stations in said network.

12. A method for use on a mobile station connected to a network, said method comprising the steps of:
selecting a set of one or more candidate target base stations;
performing autonomous signaling discovery and detection on said set of one or more candidate target base stations over the same or across a plurality of access technologies;
updating said selection based on measurements obtained via said autonomous signaling discovery and detection;
initiating a handover procedure to a specific candidate target base station.

13. The method according to claim 12, wherein said autonomous signaling discovery and detection is performed without any negotiation with the network.

14. The method according to claim 12, wherein said step of initiating comprises the step of requesting a handover from said network to said specific candidate target base station.

15. The method according to claim 12, wherein said step of initiating comprises the step of providing said measurements to said network thereby triggering a network decision to perform a handover to said specific candidate target base station.

16. A method of maintaining connectivity between a mobile station and a plurality of target base stations in a network, said method comprising the steps of:
autonomously detecting potential target base stations in said network to generate a candidate target base station list;
autonomously performing signal discovery and detection measurements on said candidate target base stations over the same or across a plurality of access technologies;
ranking base stations in said candidate target base station list in accordance with a predefined criteria; and
autonomously updating said signal discovery and detection measurements and updating said candidate target base station list in accordance therewith.

17. The method according to claim 16, wherein said autonomous signaling discovery detection is performed without any negotiation with the network.

18. The method according to claim 16, wherein said parameters comprise parameters that affect the handover process and can be measured or obtained from a candidate target base station without assistance thereby.

19. An apparatus for maintaining connectivity between a mobile station and a plurality of target base stations in a network, comprising:
a modem operative to receive and transmit radio frequency (RF) signals over said network, said modem comprising a cellular connectivity decoder;
a memory for storing candidate target base stations and parameter information associated therewith;
a processor coupled to said modem, said processor operative to:
autonomously detect potential target base stations in said network to generate a candidate target base station list;
autonomously perform signal detection and measurements on said candidate target base stations over the same or across a plurality of access technologies;
rank base stations in said candidate target base station list in accordance with a predefined criteria; and
autonomously update said signal detection and measurements and update said candidate target base station list in accordance therewith.

20. The apparatus according to claim 19, wherein said autonomous signal detection and measurements are performed without any negotiation with the network.

21. The apparatus according to claim 19, wherein said measurements comprise parameters that affect the handover process and that can be measured or obtained from a candidate target base station without assistance therefrom.

22. The apparatus according to claim 19, wherein said processor is further operative to perform a handover from a serving base station to a selected target base station utilizing said measurements, thereby minimizing switching time to said selected target base station.

23. A mobile station, comprising:
a radio transceiver and associated media access control (MAC) operative to receive and transmit signals over a radio access network (RAN) to a serving base station and to receive signals over said RAN from one or more target base stations;
connectivity means coupled to said radio transceiver for maintaining connectivity to a plurality of target base stations in a network, said connectivity means operative to:
select a set of one or more candidate target base stations;
perform autonomous signaling discovery and detection on said set of one or more candidate target base stations over the same or across a plurality of access technologies;
update said selection based on measurements obtained via said autonomous signaling discovery and detection; and
a processor operative to send and receive data to and from said radio transceiver and said connectivity means.

24. The mobile station according to claim 23, wherein connections to said selected group of candidate target base stations are maintained autonomously such that a serving base station is unaware of said connectivity.

25. The mobile station according to claim 23, wherein said connectivity means is operative to decode control and data from said one or more candidate target base stations in parallel with s serving base station.
